(19) United States
(12) Patent Application Publication
(10) Pub. No.: US 2023/0050958 A1
(43) Pub. Date: Feb. 16, 2023

(54) METHOD FOR OBTAINING ONE OR MORE PROTEIN PREPARATIONS AND OIL FRACTIONS FROM SUNFLOWER SEEDS OR RAPE SEEDS

(71) Applicant: Fraunhofer-Gesellschaft zur Förderung der Angewandten Forschung e.V, Muenchen (DE)

(72) Inventors: Peter EISNER, Freising (DE); Stephanie MITTERMAIER, Freising (DE)

(21) Appl. No.: 17/792,040

(22) PCT Filed: Jan. 15, 2021
(86) PCT No.: PCT/EP2021/050805

§ 371 Date: Jul. 11, 2022

(30) Foreign Application Priority Data
Jan. 24, 2020 (DE) 10 2020 200 863.9
Feb. 10, 2020 (DE) 10 2020 201 598.8
Jan. 15, 2021 (EP) PCT/EP2021/050805

(51) Int. Cl. A23L 33/185; A23J 1/14; C11B 1/00; A23K 10/30; A23K 50/75

(52) U.S. Cl. CPC A23L 33/185; A23J 1/14; C11B 1/00; A23K 10/30; A23K 50/75

(57) ABSTRACT

In a method for obtaining one or more protein preparations and oil fractions from sunflower seeds or rape seeds, at least three fractions are provided or formed from the seeds, of which a first fraction has a shell content of <1 mass percent, a second fraction has a shell content of <20 mass percent or <10 mass percent, the shell content being greater than the shell content of the first fraction but equal to at least >0.3 mass percent or >0.15 mass percent, and a third fraction has a shell content of >60 mass percent or >30 mass percent. Oil is separated from the first fraction by means of one or de-oiling steps to a residual oil content of <3 mass percent, whereby one or more oil fractions and an oil-free first fraction are obtained as protein preparations. The method makes it possible to convert all of the fractions which are accumulated during the preparation of the sunflower seeds or rape seeds, into ingredients of the highest possible quality for food, animal feed, energy or technical applications.

### FIELD OF APPLICATION

The invention relates to a method for obtaining one or more protein preparations and oil fractions from sunflower seeds or rape seeds, and protein preparations obtained therefrom. Fractions provided or formed from the seeds in the course of the method can be used as food ingredients, animal feed, technical auxiliary substances, energy carriers or as feed additive or bedding in animal husbandry.

### RELATED ART

Against a background of dwindling agricultural areas and resources, plant-based protein preparations are becoming more and more important all the time, for feeding Mankind, for technical applications and for use in animal feed.

An inexpensive source for food and animal feed proteins are the residues from the pressing and extraction processes used to obtain cooking oil from sunflower seeds and rape seeds. These seeds are characterized by a firm shell, mostly of dark colouring, and an oil-containing fruit flesh. It is possible to separate the shells of these raw materials, but the process and equipment for doing this is immensely complex, especially in the case of rape seeds.

Today, the residues from pressing and extraction processes used to recover oil are mainly used as animal feed. But despite their high protein content, their use remains limited. This is due on the one hand to a very high shell content in the residue, which is typically over 25 mass percent, and in some cases may even exceed 50 mass percent. Moreover, the level of undesirable impurities is very high, particularly the content of phytochemicals such as polyphenols, tannins, gluco-sinolates or phytic acid. These components may make up a cumulative total of more than 10 mass percent in the residues and considerably impair the colour, taste and digestibility of the proteins. Press cakes and extraction residues obtained in the recovery of sunflower and rape oil are therefore not suitable for manufacturing high quality protein flours for food and animal feed, and because of the phytochemicals they contain they are only suitable for feeding certain types of animal, and then only in small quantities.

According to the related art, sunflower and rape seeds are processed with the primary objective of obtaining a high oil yield. In this context, they first have impurities removed, then they are partially conditioned (defined temperature and humidity are set), then the undergo mechanical preliminary de-oiling by pressing (maximum residual oil contents 10 mass percent) and then the residual oil content is extracted from the press cakes with hexane. A “final pressing” to reach residual oil contents of about 5 mass percent is also carried out with no subsequent extraction, although the residual oil content in the press cakes shortens the storage stability of the residues.

Until now, sunflower seeds and rape seeds were usually not de-hulled or only partially de-hulled before pressing. With partial de-hulling, over 50 mass percent of the shells contained in the seeds remain in the raw material before de-oiling, which corresponds on average to a remaining shell content before pressing of >12 mass percent for sunflower seeds and >8 mass percent for rape seeds. According to the related art, a higher shell content is considered necessary, especially for pressing, —i.e. final pressing or initial pressing as partial de-oiling—in order to make it easier for the oil to drain out of the press and thus increase throughput through the presses.

In the last few years, there have also been attempts to convert the proteins from the residues of sunflower or rape oil recovery into protein flours or concentrates, thereby making them usable for food and high-quality animal feed applications. Some publications describe the production of protein concentrates from rape seeds and sunflower seeds. These protein concentrates are recovered with dry or wet preparation technologies (e.g., with the use of solvents), wherein the protein remains in the residue. However, the use of the residues as animal feed is limited due to the high level of undesirable impurities and their high crude fibre content, so that often no particular advantage compared with the sunflower and rape extraction meals is discernible. Most of such protein concentrates therefore have a limited application range and can only be used in low concentrations in animal feeds.

EP 2 885 980 B1 describes among other things a method for obtaining sunflower protein as a protein-rich foodstuff or animal feed. In order to produce the animal feeds, shelled sunflower kernels having a remaining shell content of >5 mass percent are used. The seed goods are pressed until an oil content ≥8 mass percent to ≤18 mass percent and a protein content from ≥30% to ≤45% relative to dry mass is reached. The effect of a lower remaining shell content on the digestibility of the proteins is not discussed. Moreover, in this case too it must be assumed that the high crude fibre content and the high chlorogenic acid content of the product may also significantly limit its acceptance and therewith its usability as animal feed. On the other hand, it is not disclosed in the filing whether this method enables complete reuse of all fractions the seeds.

WO 2010097238 A2 also describes a method for producing protein preparations from de-hulled sunflower seeds. With this method, the sunflower seeds are de-hulled until a remaining shell content of ≤5 mass percent is reached, or de-hulled sunflower seeds with a remaining shell content of ≤5 mass percent are provided. The de-hulled sunflower seeds undergo mechanical partial de-oiling by pressing until a fat or oil content for the de-hulled sunflower seeds in the range from 10 to 35 mass percent is reached. After one or more extraction steps have been carried out with at least one solvent, a defatted protein-containing flour is obtained as the protein preparation. The protein preparation has very favourable properties, both visually and functionally, which permit it to be used in both the human food and animal feed sectors. Due to the low temperatures of less than 80° C. during pressing and less than 90° C. during desolventising, with this method it becomes possible to ensure that good technofunctional properties are preserved, a low degree of denaturation occurs, which in turn suggests very good digestibility and bioavailability. However, the low temperatures of less than 90° C. used in the course of processing the sunflower seeds entail very long residence times in the solvent-based process stages when the method is used industrially, and costs for the process.

In document EP 2163159 B1, a method is described for using oil plants (e.g., from rape, sunflowers, flax or camelina), in which oil is recovered and at least some of the seed shells are removed from the remaining plant constituents that accumulate during oil recovery and at least some proteins are recovered. The deproteinised plant constituents are at least partially processed to recover energy therefrom, particularly in order to generate electrical power and/or usable heat. This enables a largely complete use of the fractions in oil seeds in the form of protein for food and animal feed applications, and the carbohydrate-rich fraction with the proteins removed as energy carrier.

The object of the present invention consists in presenting a method for recovering one or more protein preparations and oil fractions from the seeds of sunflowers or rape, in which all fractions that are accumulated during the preparation of the sunflower seeds or rape seeds are able to be converted into ingredients of the highest possible quality for food, animal feed, energy and technical applications.

### SUMMARY OF THE INVENTION

This object is solved with the method according to Claims 1 and 2. Claims 15 and 16 describe protein preparations which are obtained with the method. Advantageous variants and further developments of the method are the objects of the dependent claims or may be discerned from the following description and exemplary embodiments.

With the method according to the invention, seeds of either sunflowers or rape are first shelled, and the kernels are then de-hulled and separated by sieving, winnowing and sorting in such manner that at least three fractions with the shell fractions indicated below are obtained, or fractions of sunflower or rape seeds already having these shell contents are provided. According to the invention, the following steps are carried out in the method.

In the case of sunflower seeds
a first fraction is separated or provided, having a shell content less than 1 mass percent, advantageously less than 0.5 mass percent, particularly advantageously less than 0.1 mass percent,
wherein the first fraction is processed further to yield a first protein preparation by at least partial separation of the oil until a residual oil content <3 mass percent, advantageously <2 mass percent is reached, and at the same time one or more oil fractions are obtained, and
a second fraction is obtained or provided, in which the shell content is greater than that of the first fraction, but at all events is at least equal to more than 0.3 mass percent, advantageously more than 1 mass percent, particularly advantageously more than 5 mass percent but less than 20 mass percent, advantageously less than 10 mass percent,
wherein oil is separated from the second fraction, whereby one or more further oil fractions is/are obtained, and in an advantageous variant a second protein preparation is recovered through at least partial separation of the oil until a residual oil content less than 10 mass percent, advantageously less than 3 mass percent is reached, and
a third fraction—hereinafter also referred to as the shell fraction—with a shell content greater than 60 mass percent, advantageously greater than 80 mass percent and less than 99 mass percent, advantageously less than 90 mass percent is separated or provided.

In the case of rape seeds
a first fraction is separated or provided, having a shell content less than 1 mass percent, advantageously less than 0.5 mass percent, particularly advantageously less than 0.1 mass percent,
wherein the first fraction is processed further to yield a first protein preparation by at least partial separation of the oil until a residual oil content <3 mass percent, advantageously <2 mass percent is reached, and at the same time one or more oil fractions are obtained, and
a second fraction is obtained or provided, in which the shell content is greater than that of the first fraction, but at all events is at least equal to more than 0.15 mass percent, advantageously more than 0.5 mass percent, particularly advantageously more than 2.5 mass percent but less than 10 mass percent, advantageously less than 5 mass percent,
wherein oil is separated from the second fraction, whereby one or more further oil fractions is/are obtained, and in an advantageous variant a second protein preparation is recovered through at least partial separation of the oil until a residual oil content less than 10 mass percent, advantageously less than 3 mass percent is reached, and
a third fraction—hereinafter also referred to as the shell fraction—with a shell content greater than 30 mass percent, advantageously greater than 60 mass percent and less than 99 mass percent, advantageously less than 90 mass percent is separated or provided.

Advantageously, for both sunflower seeds and rape seeds further fractions are obtained or provided which also contain proteins from the kernels of sunflower seeds or rape seeds and from which oil and a protein-containing residue can be recovered, the protein content of which is greater than that of the shells.

Surprisingly, with this process organisation based on the provision and/or formation of the multiple fractions with the shell contents indicated, it is possible to significantly reduce the average amount of energy that must be consumed to obtain a kg of shelled kernels. The specific energy requirement is compared in this case with the energy consumption need to produce or provide just one fraction, wherein the one fraction in total has the same mass as two or more fractions according to the invention and on average contains the same percentage of shells as the fractions according to the invention. By rejecting multiple fractions with differing shell content, in some cases it is even possible to dispense entirely with the need to pass single fractions through the shelling and sorting unit multiple times, since a correspondingly higher shell content also lends itself to direct use and therefore no further processing is needed.

The method of allocating the fractions according to the invention makes it possible to convert all fractions accumulated into ingredients for food, animal feed, energy or technical applications. Particularly the provision or formation of the first fraction results in a high-quality protein preparation for food.

It has also been found that the fractionation described enables an easy way to successfully recover vegetable oils having different properties simultaneously from an input stream. With the appropriate process management, particularly by reducing the shell content in a fraction to less than 0.1 mass percent and possibly in a second fraction to values below 1 mass percent, it is possible to attain an outcome in which one or more oil fractions can be used directly without further treatment (e.g., refining), whereas other fractions should undergo further processing. Thus, there are sometimes considerable differences between the oils from the first fraction, the second fraction and any possible further fractions in terms of their composition, and also with regard to their taste and colour. The content of taste-active phytochemicals such as tannins also varies significantly between oils from the first and second fractions, both in the case of sunflower seeds and for rape seeds. Accordingly, these oils for different applications may be used directly after simple filtration or following a further preparation step (e.g., refining or mixing with other fractions) in targeted manner on various markets for different applications.

For example, the oil that is recovered from the first fraction from sunflower seeds is characterized in that it contains no cuticular waxes, or only traces of waxes, and has a mild, nutty flavour. In contrast, oils from the second fraction have larger wax contents, they taste slightly bitter and they are slightly darker in colour. This fraction would therefore be used rather in the unrefined condition for technical applications, or would only be used for human food after undergoing a full refinement process including winterising, degumming, deacidification, bleaching and deodorisation.

Thus, surprisingly, the fractionation of sunflower seeds and rape seeds according to the invention makes possible for the amount of oil that has to undergo refinement to be reduced. This saves energy and the use of chemicals that are essential for deacidifying or deodorising oils according to the related art. Moreover, oil losses that inevitably accompany each step of the conventional oil refining process are reduced. On the basis of the present invention, the vegetable oil manufacturing process can be organised much more efficiently per kg of input material with regard to resources and energy than the methods according to the related art, and in particular, higher oil yields are realised.

With the fractionation process according to the invention it is easily possible to produce or provide variable quantities of the individual fractions according to market demand or raw materials properties, so that a particularly efficient operation in respect of usability and thus also resource usage may also be realised with the aid of the method. In pilot experiments, it was found that the first fraction should advantageously contain between 1 and 80% of the quantity of kernels that are supplied to the overall process through the starter material, the level is advantageously between 5 and 35%, particularly advantageously between 15 and 25%. With this proportion of kernels in the highly purified first fraction enables, particularly simple and inexpensive operation is possible, and a significant proportion of the oil can be used without treatment and does not have to be refined.

A protein preparation recovered from the first fraction of rape seeds should be processed further for use in human food as carefully as possible to preserve its high functionality and good sensory properties.

Thus for example, the shell content in the first fraction should be <1 mass percent, particularly advantageously <0.1 mass percent, and in an advantageous variant the pressing or mechanical de-oiling of the kernels should be carried out until an oil content of >10 mass percent to <30 mass percent, advantageously between 10 and 20 mass percent is reached, with an average temperature of the first fraction below 80° C., advantageously below 60° C. for the duration of the pressing process. In a subsequent solvent treatment with an organic solvent, e.g., hexane, supercritical CO2 or ethanol, further oil depletion takes place until the residual oil content has a value below 3 mass percent, advantageously below 2 mass percent.

The protein preparation from rape seeds obtained in this treatment of the first fraction is highly functional and then has the following properties:

It has a protein content of less than 90 mass percent relative to the dry mass (TS), advantageously <70 mass percent, has a lightness L* of >70, advantageously >80, determined according to CIE-L*a*b*-colorimetry, and possesses at least water-binding, oil-binding and emulsifying functionalities. In this context, the water-binding capacity of the preparation is equal to >1 ml per gram TS, preferably >2 ml per gram TS, particularly preferably >3 ml per gram TS. The oil-binding capacity is equal to >0.5 ml/g TS, preferably >1 ml/g TS, and the emulsifying capacity is equal to >300 ml/g TS, preferably >500 ml/g, particularly preferably >600 ml/g. The protein solubility in the preparation is greater than 30%, particularly preferably greater than 60%.

A protein preparation recovered from the first fraction of sunflower seeds should also be processed further for use as carefully as possible to preserve its high functionality ad good sensory properties.

Thus for example, the shell content in the kernel fraction should be <1 mass percent, particularly advantageously <0.1 mass percent, and in an advantageous variant the pressing or mechanical de-oiling of the kernels should be carried out until an oil content of >10 mass percent to <30 mass percent, advantageously between 10 and 20 mass percent is reached, with an average temperature of the first fraction below 80° C., advantageously below 60° C. for the duration of the pressing process. In a subsequent solvent treatment with an organic solvent, e.g., hexane, supercritical CO2 or ethanol, further oil depletion takes place until the residual oil content has a value below 3 mass percent, advantageously below 2 mass percent.

According to the invention, the protein preparation from sunflower seeds obtained in this treatment has the following properties:

It has a protein content of less than 90 mass percent relative to the dry mass (TS), advantageously <80 mass percent, particularly advantageously less than 70 mass percent, has a lightness L* of at least 70, advantageously >80, determined according to CIE-L*a*b-colorimetry, and possesses at least water-binding, oil-binding and emulsifying functionalities. In this context, the water-binding capacity of the preparation is equal to >1 ml per gram TS, preferably >2 ml per gram TS. The oil-binding capacity is equal to >0.5 ml/g TS, preferably >1 ml/g TS, and the emulsifying capacity is equal to >300 ml/g TS, preferably >400 ml/g, particularly preferably >500 ml/g. The protein solubility in the preparation is greater than 25%, particularly preferably greater than 40%.

With the method according to the invention, it is also possible with sunflower kernels to produce a further fraction besides the first and second fractions, which is also practically free from shells, but which can be used not to produce oil and protein but instead for direct consumption. This fraction is advantageously formed from a very high proportion of visually appealing, unbroken kernels. The proportion is advantageously equal to more than 70% of kernel mass, particularly advantageously more than 90% of the kernel mass in this fraction. For the first fraction, there is no limit set for the proportion of broken kernels, since for pressing the kernels a high proportion >30% of broken kernels is more of an advantage, since the greater resistance of broken kernels to conveying by the screw during pressing simplifies the pressing process. The proportion of broken kernels in the first fraction will therefore advantageously be greater than 50%, particularly advantageously greater than 70% for both sunflower seeds and rape seeds.

### BRIEF DESCRIPTION OF THE DRAWINGS

In the following text, the suggested method will be explained again, in greater detail, with reference to exemplary embodiments and in conjunction with the drawings. In the drawings:

FIG. 1 is a schematic diagram of an exemplary configuration of the method for the preparation of sunflower seeds; and

FIG. 2 is a schematic diagram of an exemplary configuration of the method for the preparation of rape seeds.

### EXEMPLARY EMBODIMENTS

### Example 1

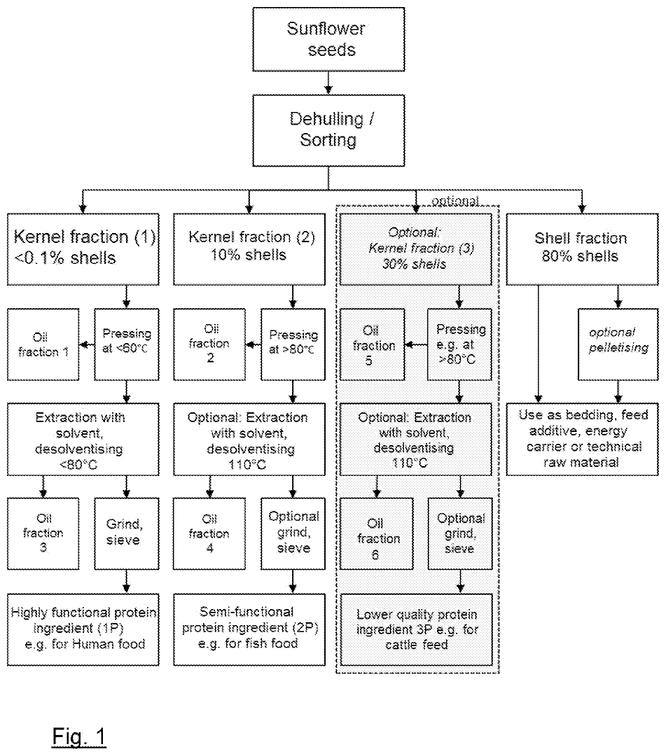

In this example, as represented schematically in FIG. 1, three fractions were recovered using an impact dehuller followed by several sieving, winnowing and sorting cycles from sunflower seeds that had been cleaned of contaminants as far as possible:

25 mass percent of an ultrapure first fraction, referred to hereafter as kernel fraction (1), with a shell content of <0.1 mass percent,

20 mass percent of a second fraction, referred to hereafter as kernel fraction (2), with a shell content of 10 mass percent,

10 mass percent of a third fraction, referred to hereafter as kernel fraction (3), with a shell content of 30 mass percent, and

30 mass percent of a shell fraction, which had a shell content of 80 mass percent.

Kernel fraction (1) was pressed at moderate temperatures (<60° C.) until a residual oil content of 18 mass percent was reached. After filtration, the oil obtained was a very mild, nutty flavoured cooking oil with yellowish colour, and which could be used as cooking oil after particles causing cloudiness were separated.

The press cake was de-oiled with hexane and desolventised at low temperatures below 80° C. Then, the solid material was ground to analytical fineness (particle size predominantly <100 μm) in a laboratory mill and evaluated with regard to colour and functional properties.

The protein flour thus obtained as the first protein ingredient (1P) had a protein content relative to TS of 59% (factor 6.25), a remaining oil proportion of 2% and presented a lightness value L* of 85 according to CIE L*a*b*. It had a neutral, slightly nutty flavour. The protein of the preparation was 40% soluble at pH 7 and presented an emulsifying capacity of 480 ml per gram protein. Accordingly, as a highly functional food additive this fraction is clearly usable in many applications with stringent requirements.

Kernel fraction (2) was pressed at 90° C. until an oil content of 10 mass percent was reached. After filtration, the oil obtained had a slightly bitter taste and a slightly cloudy appearance with yellowish colour. It can be treated further in a refinement process to produce a cooking oil.

The press cake from this pressing was also de-oiled with hexane and desolventised in the drying cabinet at a temperature of 110° C. Then, the solid material was ground to analytical fineness (particle size predominantly <100 μm) in a laboratory mill and evaluated with regard to colour and functional properties.

The protein flour thus obtained as the second protein preparation (2P) had a protein content relative to TS of 54% (factor 6.25), a residual fat content of 1.8% and presented a lightness value L* of 68 according to CIE L*a*b*. It had a mildly bitter flavour and left a rough feeling in the mouth. The protein of the flour was 25% soluble at pH 7 and presented an emulsifying capacity of 320 ml per gram. Accordingly, is not suitable for use as an ingredient in human food, but is certainly usable in high-standard animal feed applications, for example in fish food or pet food.

Kernel fraction (3) was also processed similarly to kernel fraction (2). Due to the high shell content, the oil was still darker, and slightly more bitter, so it was essential for the fraction to undergo refining.

The protein flour thus obtained as the third protein ingredient (3P) had a protein content relative to TS of 39% (factor 6.25), a residual fat proportion of 1.7% and presented a lightness value L* of 40 according to CIE L*a*b*. It had a bitter flavour and caused a very rough feeling in the mouth. The protein of the flour was 255 soluble at pH 7 and presented an emulsifying capacity of 250 ml per gram. Accordingly, this fraction only lends itself for use in simple animal feed applications e.g., for cattle.

The shell fraction thus obtained consisted mainly (approx. 80%) of shells and some remaining kernel pulp, and was not examined further; the oil fractions recovered after de-oiling with hexane were also not further analysed.

### Example 2

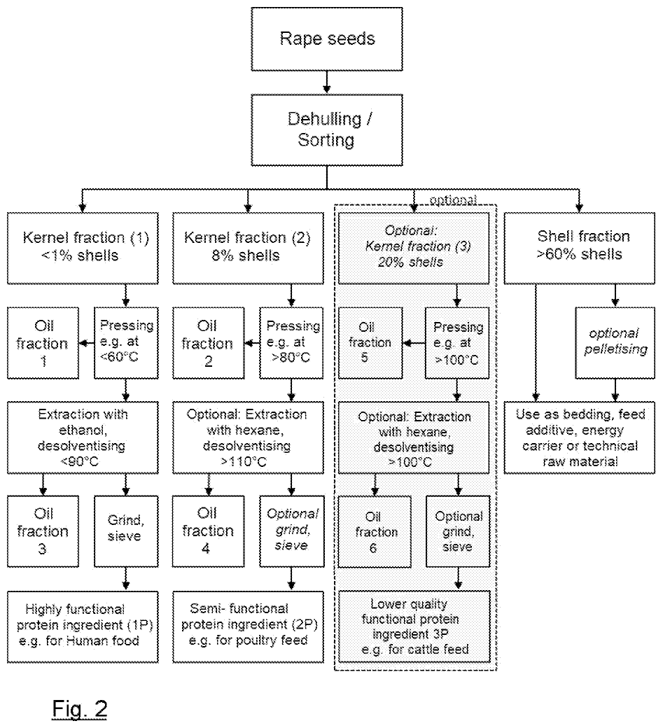

In this example, as represented schematically in FIG. 2, three fractions were recovered using an impact dehuller followed by several sieving, winnowing and visual and manual sorting cycles from rape seeds that had been cleaned of contaminants as far as possible:

35 mass percent of an ultrapure first fraction, referred to hereafter as kernel fraction (1), with a shell content of <1 mass percent,

30 mass percent of a second fraction, referred to hereafter as kernel fraction (2), with a shell content of 8 mass percent,

20 mass percent of a third fraction, referred to hereafter as kernel fraction (3), with a shell content of 20 mass percent, and

15 mass percent of a shell fraction, which had a shell content of 60 mass percent.

Kernel fraction (1) was pressed at moderate temperatures (<60° C.) until a residual oil content of 22 mass percent was reached. After filtration, the oil obtained was a very mild tasting, clear cooking oil with yellow colour, and faint note of mustard.

The press cake was de-oiled with ethanol and desolventised at low temperatures below 90° C. Then, the solid material was ground to analytical fineness (particle size predominantly <100 μm) in a laboratory mill and evaluated with regard to colour, sensory impressions and functional properties.

The protein flour thus obtained as the first protein preparation (1P) had a protein content relative to TS of 58% (factor 6.25), a remaining fat proportion of 1.8% and presented a lightness value L* of 80 according to CIE L*a*b*. It had a neutral, slightly tangy flavour with faint note of mustard. The protein of the preparation was 55% soluble at pH 7 and presented an emulsifying capacity of 610 ml per gram protein. Accordingly, as a highly functional food additive this fraction is usable in many spicy applications.

Kernel fraction (2) was pressed at 90° C. until an oil content of 12 mass percent was reached. After filtration, the oil obtained had a slightly bitter taste and a slightly cloudy appearance with yellow colour. It can be treated further in a refinement process to produce a cooking oil.

The press cake from this pressing was de-oiled with hexane and desolventised in the drying cabinet at a temperature of 110° C. Then, the protein was ground to analytical fineness (particle size predominantly <100 μm) in a laboratory mill and evaluated with regard to colour and functional properties.

The protein flour thus obtained as the second protein preparation (2P) had a protein content relative to TS of 51% (factor 6.25), a residual fat content of 2% and presented a lightness value L* of 65 according to CIE L*a*b*. It had a mildly bitter flavour and left a rough feeling in the mouth. The protein of the flour was 25% soluble at pH 7 and presented an emulsifying capacity of 370 ml per gram. Accordingly, this fraction is not suitable for use as an ingredient in human food, but is certainly usable in animal feed applications, for example in poultry feed.

Kernel fraction (3) was also processed similarly to kernel fraction (2). Due to the high shell content and harsh processing conditions, the oil was still darker, and slightly more bitter.

The protein flour thus obtained as the third protein preparation (3P) had a protein content relative to TS of 37% (factor 6.25), a residual fat proportion of 1.8% and presented a lightness value L* of 35 according to CIE L*a*b*. It had a bitter flavour and caused a very rough feeling in the mouth. The protein of the flour was 25% soluble at pH 7 and presented an emulsifying capacity of 250 ml per gram. Accordingly, this fraction only lends itself for use in simple animal feed applications e.g., for cattle.

The shell fraction obtained consisted mainly (approx. 60%) of rapeseed shells and some remaining kernel pulp. As with the sunflower shell fraction, it was not examined further; the same also applied for the oil fractions recovered after de-oiling with solvent.

In the present patent application, the following determination procedures were used for the quantitative determination of the properties and values declared:

Protein Content:
The protein content is defined as the content that is calculated from the nitrogen determination multiplied by the factor 6.25. The protein content is expressed for example as a percentage relative to the dry mass (TS).

Colour:
The perceptible colour is determined using CIE-L*a*b*-colorimetry (see DIN 6417). In this context, the L*-axis indicates the lightness, wherein black has the value 0 and white has the value 100, the a*-axis describes the green or red component, and the b*-axis describes the blue or yellow component.

Protein Solubility:
Protein solubility is determined using determination methods according to Morr et al. 1985 (see journal article: Morr C. V., German, B., Kinsella, J. E., Regenstein, J. M., Van Buren, J. P., Kilara, A., Lewis, B. A., Mangino, M. E, “A Collaborative Study to Develop a Standardized Food Protein Solubility Procedure. Journal of Food Science”, volume 50 (1985) pages 1715-1718). The protein preparation is suspended in a 0.1 M NaCl-solution at room temperature in a mass volume percentage from 1:25 to 1:50 (w/v) (i.e. 1-2 g of the protein preparation to 50 ml solution), and maintained for about 60 min at a pH 7 using 0:1 M HCl-solution or NaOH-solution, and stirred at about 200 rpm, and the insoluble sediment is subsequently centrifuged for 15 minutes at 20,000 times the acceleration of the Earth (20,000 g). The protein solubility may be stated in percent, for example, wherein a protein solubility of x % means that x % of the protein present in the preparation will be present in the clarified supernatant is the described method is used.

Water Binding:
The water-binding capacity is determined by means of the AACC determination procedure as defined in: American Association of Cereal Chemists, “Approved methods of the AACC”. 10th ed., AACC. St. Paul, Minn., 2000b; Method 56-20. “Hydration capacity of pregelatinized cereal products”. The water-binding capacity can be stated for example in ml/g, i.e. millilitres of bound water per gram of preparation, and is determined according to the AACC determination procedure using the weight of the sediment saturated with water minus the weighed in amount of the dry preparation after mixing approx. 2 g protein preparation with approx. 40 ml water for 10 minutes and centrifuging at 1000 g for 15 minutes at 20° C.

Oil Binding:
The oil-binding capacity is determined using a determination method as described in: Ludwig I., Ludwig, E., Pingel B., “Eine Mikromethode zur Bestimmung der Fettbindekapazität [A micromethod for determining fat-binding capacity]”. Nahrung/Food, 1989, 33(1), 99.
The oil-binding capacity can be stated in ml/g, for example, i.e. millilitres of bound oil per gram of preparation, and is measured according to the abovementioned determination procedure as the volume of the oil-binding sediment after mixing 1.5 g protein preparation with 15 ml maize-germ oil for 1 minute and centrifuging at 700 g for 15 minutes at 20° C.

Emulsifying Capacity:
The emulsifying capacity is determined by means of the “conductivity measurement method”, in which 100 ml of maize germ oil, pH 7, is added to a 1% suspension of the protein preparation until phase inversion of the oil-in-water emulsion. The emulsifying capacity is defined as the maximum oil absorption capacity of said suspension, determined on the basis of the spontaneous fall in conductivity upon phase inversion (see journal article by Wäsche, A., Müller, K., Knauf, U., “New processing of lupin protein isolates and functional properties”. Nahrung/Food, 2001, 45, 393-395) and may be expressed for example in ml oil/g, i.e. millilitres of Emulsified Oil Per Gram Protein Preparation.

Residual Oil Content:
The residual oil content is determined using Soxhlet Method AOAC 963.15, i.e. by gravimetric determination following Soxhlet extraction.

1. Method for obtaining at least one protein preparation and several oil fractions from the seeds of sunflowers, which comprises at least the following steps:
providing or forming at least three fractions from the seeds, of which
a first fraction has a shell content of <1 mass percent,
a second fraction has a shell content of <20 mass percent, which is greater than the shell content of the first fraction, but is at least >0.3 mass percent, and
a third fraction has a shell content of >60 mass percent,
separating oil from the first fraction through one or more de-oiling steps down to a residual oil content of <3 mass percent, with the result that one or more oil fractions and an oil-free first fraction as a first protein preparation are obtained, and
separating oil from the second fraction, with the result that one or more further oil fractions are obtained.

2. Method for obtaining at least one protein preparation and several oil fractions from rape seeds, which comprises at least the following steps:
providing or forming at least three fractions from the seeds, of which
a first fraction has a shell content of <1 mass percent,
a second fraction has a shell content of <10 mass percent which is greater than the shell content of the first fraction, but is at least >0.15 mass percent, and
a third fraction has a shell content of >30 mass percent,
separating oil from the first fraction through one or more de-oiling steps down to a residual oil content of <3 mass percent, with the result that one or more oil fractions and an oil-free first fraction as a first protein preparation are obtained, and
separating oil from the second fraction, with the result that one or more further oil fractions are obtained.

3. Method according to claim 1,
characterized in that
forming the at least three fractions comprises the following steps:
shelling the seeds and
removing a part of the shells by sieving and/or winnowing and/or sorting in such manner that the at least three fractions are obtained with the stated shell contents.

4. Method according to claim 1, characterized in that
one or more further fractions is/are provided or formed that contain proteins from the kernels of the sunflower seeds or rape seeds, and from which oil and a protein-containing residue are then recovered, each having a protein content which is greater than a protein content of the shells.

5. Method according to claim 1, characterized in that
the separation of oil from the first fraction is carried out by mechanical partial de-oiling of the first fraction to obtain a first oil fraction and a first residue fraction, und subsequent solvent extraction once or multiple times from the first residue fraction.

6. Method according to claim 5,
characterized in that
the mechanical partial de-oiling is carried out at an average temperature of the first fraction below 80° C. for the duration of the mechanical partial de-oiling to reach an oil content of >10 mass percent and <30 mass percent.

7. Method according to claim 1, characterized in that
the provision or formation of the at least three fractions from the seeds takes place in such manner that the first fraction contains between 1 and 80%, advantageously between 5 and 35%, particularly advantageously between 15 and 25% of the quantity of kernels that are present in the starting material for the method.

8. Method according to claim 1, characterized in that
the provision or formation of the at least three fractions from the seeds takes place in such manner that the third fraction has a shell content of >80 mass percent and <99 mass percent, advantageously <90 mass percent in the case of seeds from sunflowers and a shell content of >60 mass percent and <99 mass percent, advantageously <90 mass percent in the case of seeds from rape.

9. Method according to claim 1, characterized in that
the provision or formation of the at least three fractions from the seeds takes place in such manner that the first fraction has a shell content von <0.5 mass percent, advantageously <0.1 mass percent.

10. Method according to claim 1, characterized in that
the provision or formation of the at least three fractions from the seeds takes place in such manner that the second fraction has a shell content of <10 mass percent in the case of seeds from sunflowers, and a shell content <5 mass percent in the case of seeds from rape.

11. Method according to claim 1, characterized in that
the separation of oil from the first fraction is carried out through the one or several de-oiling steps until a residual oil content of <2 mass percent is reached.

12. Method according to claim 1, characterized in that
through the one or more de-oiling steps, oil is separated from the second fraction until a residual oil content of <10 mass percent, advantageously <3 mass percent is reached, as a result of which the one or more further oil fractions and an oil-free second fraction as a second protein preparation are obtained.

13. Method according to claim 12,
characterized in that
the separation of oil from the second fraction is carried out by mechanical partial de-oiling of the second fraction.

14. Method according to claim 12,
characterized in that
the separation of oil from the second fraction is carried out by mechanical partial de-oiling of the second fraction in order to obtain a second oil fraction and a second residue fraction, followed by solvent extraction once or multiple times from the second residue fraction.

15. Protein preparation from sunflower seeds which is obtained as a first protein preparation by the method according to claim 1 and has
a protein content of less than 90 mass percent relative to the dry mass, advantageously less than 80 mass percent, particularly advantageously less than 70 mass percent,
a lightness value L* according to CIE-L*a*b*-colorimetry of at least 70, advantageously >80,
a water-binding capacity of >1 ml/g dry mass, preferably >2 ml/g dry mass,
an oil-binding capacity of >0.5 ml/g dry mass, preferably >1 ml/g dry mass,
an emulsifying capacity of >300 ml/g dry mass, preferably >400 ml/g dry mass, particularly preferably >500 ml/g dry mass, and
a protein solubility of more than 25%, particularly preferably more than 40%.

16. Protein preparation from rape seeds which is obtained as a first protein preparation by the method according to claim 2 and has
a protein content of less than 90 mass percent relative to the dry mass, advantageously <70 mass percent,
a lightness value L* according to CIE-L*a*b*-colorimetry of >70, advantageously >80,
a water-binding capacity of >1 m/g dry mass, preferably >2 ml/g dry mass, particularly preferably >3 ml/g dry mass,
an oil-binding capacity of >0.5 ml/g dry mass, preferably >1 ml/g dry mass,
an emulsifying capacity of >300 ml/g dry mass, preferably >500 ml/g dry mass, particularly preferably >600 ml/g dry mass, and
a protein solubility of more than 30%, particularly preferably more than 60%.

17. Method according to claim 2,
characterized in that
forming the at least three fractions comprises the following steps:
shelling the seeds and
removing a part of the shells by sieving and/or winnowing and/or sorting in such manner that the at least three fractions are obtained with the stated shell contents.

18. Method according to claim 2,
characterized in that
one or more further fractions is/are provided or formed that contain proteins from the kernels of the sunflower seeds or rape seeds, and from which oil and a protein-containing residue are then recovered, each having a protein content which is greater than a protein content of the shells.

19. Method according to claim 2,
characterized in that
the separation of oil from the first fraction is carried out by mechanical partial de-oiling of the first fraction to obtain a first oil fraction and a first residue fraction, und subsequent solvent extraction once or multiple times from the first residue fraction.

20. Method according to claim 19,
characterized in that
the mechanical partial de-oiling is carried out at an average temperature of the first fraction below 80° C. for the duration of the mechanical partial de-oiling to reach an oil content of >10 mass percent and <30 mass percent.

21. Method according to claim 2,
characterized in that
the provision or formation of the at least three fractions from the seeds takes place in such manner that the first fraction contains between 1 and 80%, advantageously between 5 and 35%, particularly advantageously between 15 and 25% of the quantity of kernels that are present in the starting material for the method.

22. Method according to claim 2,
characterized in that
the provision or formation of the at least three fractions from the seeds takes place in such manner that the third fraction has a shell content of >80 mass percent and <99 mass percent, advantageously <90 mass percent in the case of seeds from sunflowers and a shell content of >60 mass percent and <99 mass percent, advantageously <90 mass percent in the case of seeds from rape.

23. Method according to claim 2,
characterized in that
the provision or formation of the at least three fractions from the seeds takes place in such manner that the first fraction has a shell content von <0.5 mass percent, advantageously <0.1 mass percent.

24. Method according to claim 2,
characterized in that
the provision or formation of the at least three fractions from the seeds takes place in such manner that the second fraction has a shell content of <10 mass percent in the case of seeds from sunflowers, and a shell content <5 mass percent in the case of seeds from rape.

25. Method according to claim 2,
characterized in that
the separation of oil from the first fraction is carried out through the one or several de-oiling steps until a residual oil content of <2 mass percent is reached.

26. Method according to claim 2,
characterized in that
through the one or more de-oiling steps, oil is separated from the second fraction until a residual oil content of <10 mass percent, advantageously <3 mass percent is reached, as a result of which the one or more further oil fractions and an oil-free second fraction as a second protein preparation are obtained.
